(19) United States
(12) Patent Application Publication
(10) Pub. No.: US 2003/0114565 A1
(43) Pub. Date: Jun. 19, 2003

(54) Soft and resilient ethylene copolymers and their use in golf balls

(76) Inventors: John Chu Chen, Hockessin, DE (US); James Kenneth Weddell, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/230,015

(22) Filed: Aug. 28, 2002

Related U.S. Application Data
(63) Continuation-in-part of application No. 10/108,793, filed on Mar. 28, 2002.
(60) Provisional application No. 60/279,622, filed on Mar. 29, 2001.

(51) Int. Cl. C08L 1/00

(52) U.S. Cl. 524/322

(57) ABSTRACT

Thermoplastic ionomer copolymers having high resilience (high coefficient of restitution) and softness (low Atti compressions) made by at least partially neutralizing ethylene/carboxylic acid/alkyl (meth)acrylate copolymers and their use in golf ball components. These soft, resilient ionomers can be blended, for example, with fatty acid salts.

This application claims the benefit of U.S. Provisional Application No. 60/279,622, filed Mar. 29, 2001, which is incorporated herein by reference for all purposes.

This application is a Continuation-in-Part of co-pending U.S. application Ser. No. 10/108,793 filed Mar. 28, 2002 (AD6804 US NA) which is incorporated herein in its entirety.

### BACKGROUND OF THE INVENTION

1. Field of Invention

This invention relates to ionomeric copolymers that have a unique combination of high resilience and softness. It also relates to the use of such ionomers in golf ball components (e.g., covers, mantles, intermediate layers, core, and centers of golf balls with various constructions and 1-piece balls) and other industrial applications (e.g., thermoplastic shoe soles for cleated footwear, packaging films, molded parts, and resilient foams for sporting goods).

The copolymers are melt-processible, at least partially neutralized copolymers of ethylene, C₃ to C₈ α,β ethylenically unsaturated carboxylic acid and softening co-monomer, and have a melt index (MI) and degree of neutralization such that the Atti Compression and Coefficient of Restitution each, independently, fall below certain limits as indicated in FIG. 1.

The invention also relates to the above copolymers melt blended with organic acids or salts thereof, particularly aliphatic, mono-functional organic acid(s) having fewer than 36 carbon atoms or salts thereof . Fatty acids or fatty acid salts are most preferred.

2. Description of Related Art

Typical premium golf balls include three-piece balls, two-piece balls and multi-layered balls. “Three-piece” balls typically have a spherical molded center, elastomeric thread-like material wound around the center, and either a thermoplastic or thermoset cover. “Two-piece” balls typically have a spherical molded core covered with a thermoplastic material. “Multi-layered” balls typically have a spherical molded core and one or more intermediate layers or mantles between the core and a cover.

Centers of three-piece balls and cores of two-piece balls and multi-layer balls have traditionally been made using a thermoset rubber such as polybutadiene rubber. With thermoset rubber, complex multi-step processes are needed to make cores and centers and scrap cannot be recycled. Attempts to solve these difficulties by substituting a thermoplastic for the thermoset have had limited success. Also, attempts to make premium one-piece balls have been unsuccessful. See U.S. Pat. No. 5,155,157, UK Patent Application 2,164,342A and WO 92/12206 (these references, as well as all other references set forth anywhere in this application, are incorporated herein by reference for all purposes). Balls, cores and centers made based on these references have a high cost and lack properties such as durability, softness (low Atti compression), and resilience to make them useful in premium balls.

One thermoplastic that has found utility in golf ball components and other applications for a long time are ionomers of 3 0 copolymers of alpha olefins, particularly ethylene, and C₃₋₈ α,β ethylenically unsaturated carboxylic acid. U.S. Pat. No. 3,264,272 (Rees) teaches methods for making such ionomers from “direct” acid copolymers. “Direct” copolymers are polymers polymerized by adding all monomers simultaneously, as distinct from a graft copolymer, where another monomer is grafted onto an existing polymer, often by a subsequent free radical reaction. A process for preparing the acid copolymers on which the ionomers are based is described in U.S. Pat. No. 4,351,931.

The acid copolymers may contain a third “softening” monomer that disrupts the crystallinity of the polymer. These acid copolymers, when the alpha olefin is ethylene, can be described as E/X/Y copolymers wherein E is ethylene, X is the α,β ethylenically unsaturated carboxylic acid, particularly acrylic and methacrylic acid, and Y is the softening co-monomer. Preferred softening co-monomers are C₁ to C₈ alkyl acrylate or methacrylate esters. X and Y can be present in a wide range of percentages, X typically up to about 35 weight percent (wt. %) of the polymer and Y typically up to about 50 weight percent of the polymer.

However, the “softer” ionomers based on the acid copolymers containing the “softening” monomer typically have lower than desired resilience for the golf ball applications. Therefore, the “softer” ionomers are almost always used in blends with other “stiff” ionomers to bring the resilience up to the acceptable range, which inevitably would raise the stiffness of the composition. The blending approach results in only a compromised property balance, e.g. intermediate stiffness and intermediate resilience, when applied to the golf ball applications. While the performance compromise from the blends met the near term performance needs, the need for further golf ball performance improvement, particularly simultaneously improved balance of softness and resilience, continues to be unattainable.

A wide range of cations is known for neutralizing acid moieties in the acid copolymer. The degree of neutralization is known to vary over a wide range. Typical cations include lithium, sodium, potassium, magnesium, calcium, barium, lead, tin, zinc, aluminum, and combinations of such cations. It has been reported for most ionomers that, when acid copolymers are neutralized into ionomers, the resilience improves as the degree of neutralization increases and peaks at around 50% neutralization. Further neutralization results in higher mechanical stiffness, high melt viscosity and little benefit in resilience improvement. Neutralization to 70% and higher, including up to 100%, is known, but such a high degree of neutralization results in a loss of melt-processibility or properties such as elongation and toughness. This is particularly so for copolymers with high acid levels.

### SUMMARY OF THE INVENTION

The present invention relates to ionomeric copolymers that have much enhanced resilience and higher softness (lower stiffness) and still maintain good melt processibility and overall mechanical properties. The copolymers of this invention are at least one E/X/Y copolymer where is E is ethylene, X is a C₃ to C₈ α,β ethylenically unsaturated carboxylic acid, and Y is a softening comonomer selected from alkyl acrylate and alkyl methacrylate wherein the alkyl groups have from 1-8 carbon atoms, wherein

a. X is about 2-30 wt. % of the E/X/Y copolymer, and is at least partially neutralized by one or more alkali metal, transition metal, or alkaline earth metal cations,

b. Y is about 17-40 wt. % of the E/X/Y copolymer, and

c. the copolymer has a melt index and a degree of neutralization such that the composition has an Atti Compression and a Coefficient of Restitution that each, independently, fall within area A₁-A₂-N of FIG. 1.

Melt index (MI) is measured in accordance with ASTM D-1238, condition E, at 190° C., using a 2160 gram weight, with values of MI reported in 30 grams/10 minutes. The MI of the base resin (copolymer(s) of ethylene, C₃ to C₈ α,β ethylenically unsaturated carboxylic acid, and softening monomer) should be such that the resulting neutralized resin has an MI that is measurable in accord with ASTM D-1238, condition E, at 190° C., using a 2160 gram weight. Preferably this MI (of the at least partially neutralized resin) will be at least 0.1, preferably 0.5, and more preferably 1.0 or greater. The MI of the base resin is at least 20, or at least 40, preferably at least 75, and most preferably at least 150.

The copolymers are at least partially neutralized, are melt processible and have useful physical properties. Preferably, at least about 40% of X in the composition is neutralized. More preferably, at least about 55% of X is neutralized. Even more preferably, at least about 70, and most preferably, at least about 80% of X is neutralized. Preferably, the acid copolymer base resin is neutralized by one or more alkali metal, transition metal or alkaline earth metal cations.

In accordance with further embodiments in accordance with the present invention, the copolymer has an Atti Compression and a Coefficient of Restitution that each, independently, fall within area B₁-B₂-N, C₁-C₂-N, D₁-D₂-N, or even area E₁-E₂-N of FIG. 1. Copolymers within area E₁-E₂-N are most preferred.

The weight ratio of X to Y in the copolymer is at least about 1:20.

Preferably, the weight ratio of X to Y is at least about 1:15, more preferably, at least about 1:10. Furthermore, the weight ratio of X to Y is up to about 1:1.67, more preferably up to about 1:2. Most preferably, the weight ratio of X to Y in the copolymer is up to about 1:2.2.

According to a further embodiment in accordance with the present invention, a composition comprises a blend of (a) at least one E/X/Y copolymer where E is ethylene, X is a C₃ to C₈ α,β ethylenically unsaturated carboxylic acid, and Y is a softening comonomer selected from alkyl acrylate and alkyl methacrylate wherein the alkyl groups have from 1-8 carbon atoms, wherein

a. X is about 2-30 wt. % of the E/X/Y copolymer, and is at least partially neutralized by one or more alkali metal, transition metal, or alkaline earth metal cation

b. Y is about 17-40 wt. % of the E/X/Y copolymer, and

c. the copolymer has a melt index and a degree of neutralization such that the copolymer has an Atti Compression and a Coefficient of Restitution that each, independently, fall within area A₁-A₂-N of FIG. 1, and

(b) one or more organic acids or salts thereof. Preferably, the organic acids are one or more at least partially neutralized, aliphatic, mono-functional organic acids having fewer than 36 carbon atoms or salt thereof.

Preferably, greater than 80% of all the acid components in the blend are neutralized, more preferably greater than 90% are neutralized. Most preferably, 100% of all the acid components in the blend are neutralized. The organic acids employed in the present invention are particularly those that are non-volatile and non-migratory. Fatty acids or fatty acid salts are preferred. Non-limiting, illustrative examples of fatty acids are stearic, oleic, erucic and behenic acids. Stearic and oleic acids are preferred.

The copolymer can be further blended with one or more conventional ionomeric copolymers (e.g., di-, ter- etc.). The copolymer can be blended with one or more thermoplastic resins.

The copolymer(s) of alpha olefin, C₃ to C₈ α,β ethylenically unsaturated carboxylic acid and softening monomer from which the melt processible ionomers described above are prepared can be made by methods known in the art. The copolymers include ethylene acid copolymers, particularly ethylene/(meth) acrylic acid/butyl (meth) acrylate copolymers.

### BRIEF DESCRIPTION OF FIGURE

FIG. 1 is a plot of Atti (PGA) compression versus Coefficient of Restitution (125 ft/sec initial velocity) showing the properties of molded spheres of resins of the present invention compared to other resins.

### DETAILED DESCRIPTION OF THE INVENTION

In this disclosure, the term “copolymer” is used to refer to polymers containing two or more monomers. The phrase “copolymer of various monomers means a copolymer whose units are derived from the various monomers. “Consisting essentially of” means that the recited components are essential, while smaller amounts of other components may be present to the extent that they do not detract from the operability of the present invention. The term “(meth) acrylic acid” means methacrylic acid and/or acrylic acid. Likewise, the term “(meth) acrylate” means methacrylate and/or acrylate.

All references identified throughout this Specification including those in the Description of Related Art and those to which this case claims priority are incorporated by reference as if fully set forth herein.

Soft, High Resilience Ionomer

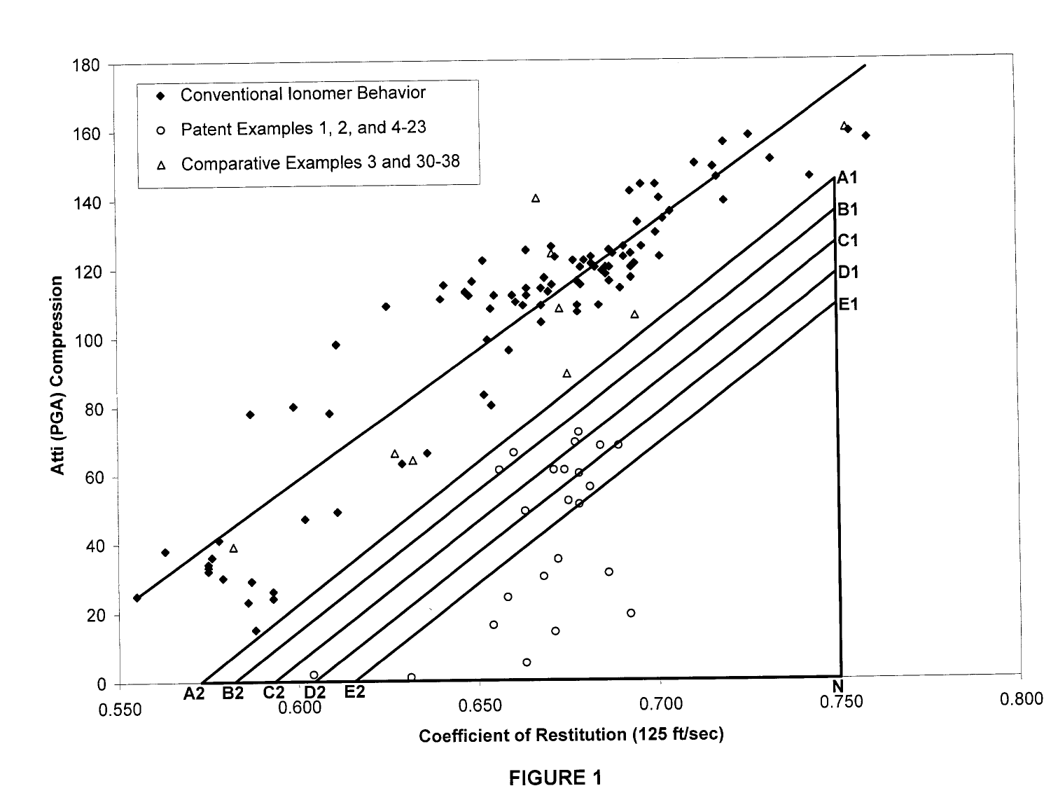

Copolymer(s) in accordance with the present invention are at least partially, preferably highly, neutralized ethylene acid copolymer wherein its crystallinity is disrupted by inclusion of a softening monomer or other means. The copolymer has a melt index and a degree of neutralization such that the copolymer has an Atti Compression and a Coefficient of Restitution that each, independently, fall within area A₁-A₂-N of FIG. 1. The resulting ionomer achieves unexpected enhancement of resilience and softness without compromising the melt processibility and the mechanical properties.

The present invention relates to a thermoplastic ionomer that is both soft and resilient. These ionomers are prepared by at least partially neutralizing acid copolymers as more fully described below under the heading “Acid Copolymers” by methods known in the art.

These soft, high resilient ionomers preferably are from neutralizing the acid copolymer(s) of at least one E/X/Y copolymer, where E is ethylene, X is the α,β ethylenically unsaturated carboxylic acid, and Y is a softening comonomer. X is preferably present in 2-30 (preferably 4-20, most preferably 5-15) wt. % of the polymer, and Y is preferably present in 17-40 (preferably 20-40, and more preferably 24-35) wt. % of the polymer, having a MI and a degree of neutralization (as both are defined below under the heading “Acid Copolymers” by methods), such that the copolymer has an Atti Compression and a Coefficient of Restitution that each independently fall within area A₁-A₂-N in FIG. 1. Preferably, the Afti Compression and Coefficient of Restitution each independently fall within area B₁-B₂-N of FIG. 1, more preferably within area C₁-C₂-N of FIG. 1 and even more preferably within area D₁-D₂-N of FIG. 1. Most preferably, the Atti Compression and Coefficient of Restitution each independently fall within E₁-E₂-N of FIG. 1. Atti Compressions and Coefficients of Restitiution that fall on the noted lines are considered to be within a specified area for purposed of the present invention. By way of non-limiting explanation as to what is intended by an Atti Compression and a Coefficient of Restitution that each independently fall below line A, reference is made to FIG. 1. It would be within the scope of this invention to have a copolymer with an Atti Compression of 40 and a COR of 0.700, as well as a copolymer having an Atti Compression of 40 and a COR of 0.650. Neutralization is achieved by using one or more alkali metal, transition metal or alkaline earth metal cations.

Preferably, the MI of the base resin is at least 20, or at least 40, more preferably, at least 75 and most preferably at least 150. Particular soft, resilient ionomers included in this invention are partially neutralized ethylene/(meth) acrylic acid /butyl (meth) acrylate copolymers having an MI and level of neutralization as described that results in a melt processible polymer that has useful physical properties. The copolymers are at least partially neutralized. Preferably at least 40, or, more preferably at least 55, even more preferably about 70, and most preferably about 80 of the acid moiety of the acid copolymer is neutralized by one or more alkali metal, transition metal, or alkaline earth metal cations. Cations useful in making the ionomers of this invention comprise lithium, sodium, potassium, magnesium, calcium, barium, or zinc, or a combination of such cations.

The present invention also relates to a “modified” soft, resilient thermoplastic ionomer that comprises a melt blend of (a) the acid copolymers or the melt processible ionomers made therefrom as described above and (b) one or more organic acid(s) or salt(s) thereof, wherein greater than 80%, preferably greater than 90% of all the acid of (a) and of (b) is neutralized. Preferably, 100% of all the acid of (a) and (b) is neutralized by a cation source. Preferably, an amount of cation source in excess of the amount required to neutralize 100% of the acid in (a) and (b) is used to neutralize the acid in (a) and (b). Blends with fatty acids or fatty acid salts are preferred.

The organic acids or salts thereof are added in an amount sufficient to enhance the resilience of the copolymer. Preferably, the organic acids or salts thereof are added in an amount sufficient to substantially remove remaining ethylene crystallinity of the copolymer.

Preferably, the organic acids or salts are added in an amount of at least about 5% (weight basis) of the total amount of copolymer and organic acid(s). More preferably, the organic acids or salts thereof are added in an amount of at least about 15%, even more preferably at least about 20%. Preferably, the organic acid(s) are added in an amount up to about 50% (weight basis) based on the total amount of copolymer and organic acid. More preferably, the organic acids or salts thereof are added in an amount of up to about 40 %, more preferably, up to about 35 %. The non-volatile, non-migratory organic acids preferably are one or more aliphatic, mono-functional organic acids or salts thereof as described below, particularly one or more aliphatic, mono-functional, saturated or unsaturated organic acids having less than 36 carbon atoms or salts of the organic acids, preferably stearic acid or oleic acid. Fatty acids or fatty acid salts are most preferred.

Processes for fatty acid (salt) modifications are known in the art. Particularly, the modified highly-neutralized soft, resilient acid copolymer ionomers of this invention can be produced by

(a) melt-blending (1) ethylene, α,β ethylenically unsaturated C₃₋₈ carboxylic acid copolymer(s) or melt-processible ionomer(s) thereof that have their crystallinity disrupted by addition of a softening monomer or other means with (2) sufficient non-volatile, non-migratory organic acids to substantially enhance the resilience and to disrupt (preferably remove) the remaining ethylene crystallinity, and then concurrently or subsequently

(b) Adding a sufficient amount of a cation source to increase the level of neutralization of all the acid moieties (including those in the acid copolymer and in the organic acid if the non-volatile, non-migratory organic acid is an organic acid) to the desired level.

In accordance with the present invention, the weight ratio of X to Y in the composition is at least about 1:20. Preferably, the weight ratio of X to Y is at least about 1 :15, more preferably, at least about 1:10. Furthermore, the weight ratio of X to Y is up to about 1:1.67, more preferably up to about 1:2. Most preferably, the weight ratio of X to Y in the composition is up to about 1:2.2.

Acid Copolymers

The acid copolymers used in the present invention to make the ionomers are preferably ‘direct’ acid copolymers (containing high levels of softening monomers) As noted above, the copolymers are at least partially neutralized such that the Atti Compression and Coefficient of Restitution each, independently, fall below the noted lines in FIG. 1. Preferably, at least about 40% of X in the composition is neutralized. More preferably, at least about 55% of X is neutralized. Even more preferably, at least about 70, and most preferably, at least about 80% of X is neutralized. In the event that the copolymer is highly neutralized (e.g., to at least 45%, preferably 50%, 55%, 70%, or 80%, of acid moiety), the MI of the acid copolymer should be sufficiently high so that the resulting neutralized resin has a measurable MI in accord with ASTM D-1238, condition E, at 190° C., using a 2160 gram weight. Preferably this resulting MI will be at least 0.1, preferably at least 0.5, and more preferably 1.0 or greater. Preferably, for highly neutralized acid copolymer, the MI of the acid copolymer base resin is at least 20, or at least 40, at least 75, and more preferably at least 150.

The acid copolymers preferably comprise alpha olefin, particularly ethylene, C₃₋₈ α,β ethylenically unsaturated carboxylic acid, particularly acrylic and methacrylic acid, and softening monomers, selected from alkyl acrylate, and alkyl methacrylate, wherein the alkyl groups have from 1-8 carbon atoms, copolymers. By “softening”, it is meant that the crystallinity is disrupted (the polymer is made less crystalline). While the alpha olefin can be a C₂-C₄ alpha olefin, ethylene is most preferred for use in the present invention. Accordingly, the present invention is described and illustrated herein in terms of ethylene as the alpha olefin.

The acid copolymers, when the alpha olefin is ethylene, can be described as E/X/Y copolymers where E is ethylene, X is the α,β ethylenically unsaturated carboxylic acid, and Y is a softening comonomer. X is preferably present in 2-30 (preferably 4-20, most preferably 5-15) wt. % of the polymer, and Y is preferably present in 17-40 (preferably 20-40, most preferably 24-35) wt. % of the polymer.

The ethylene-acid copolymers with high levels of acid (X) are difficult to prepare in continuous polymerizers because of monomer-polymer phase separation. This difficulty can be avoided however by use of “co-solvent technology” as described in U.S. Pat. No. 5,028,674 or by employing somewhat higher pressures than those at which copolymers with lower acid can be prepared.

Specific acid-copolymers include ethylene/ (meth) acrylic acid/n-butyl (meth) acrylate, ethylene/ (meth) acrylic acid/iso-butyl (meth) acrylate, ethylene/ (meth) acrylic acid/methyl (meth) acrylate, and ethylene/ (meth) acrylic acid/ethyl (meth) acrylate terpolymers.

Organic acids and Salts

The organic acids employed in the present invention are aliphatic, mono-functional (saturated, unsaturated, or multi-unsaturated) organic acids, particularly those having fewer than 36 carbon atoms. Also salts of these organic acids may be employed. Fatty acids or fatty acid salts are preferred. The salts may be any of a wide variety, particularly including the barium, lithium, sodium, zinc, bismuth, potassium, strontium, magnesium or calcium salts of the organic acids. Particular organic acids useful in the present invention include caproic acid, caprylic acid, capric acid, lauric acid, stearic acid, behenic acid, erucic acid, oleic acid, and linoleic acid.

Filler

The optional filler component of the subject invention is chosen to impart additional density to blends of the previously described components, the selection being dependent upon the different parts (e.g., cover, mantle, core, center, intermediate layers in a multilayered core or ball) and the type of golf ball desired (e.g., one-piece, two-piece, three-piece or multiple-piece ball), as will be more fully detailed below.

Generally, the filler will be inorganic having a density greater than about 4 grams/cubic centimeter (gm/cc), preferably greater than 5 gm/cc, and will be present in amounts between 0 and about 60 wt. % based on the total weight of the composition. Examples of useful fillers include zinc oxide, barium sulfate, lead silicate and tungsten carbide, as well as the other well-known fillers used in golf balls. It is preferred that the filler materials be non-reactive or almost non-reactive and not stiffen or raise the compression nor reduce the coefficient of restitution significantly.

Other Components

Additional optional additives useful in the practice of the subject invention include acid copolymer wax (e.g., Allied wax AC 143 believed to be an ethylene/16-18% acrylic acid copolymer with a number average molecular weight of 2,040), which assist in preventing reaction between the filler materials (e.g., ZnO) and the acid moiety in the ethylene copolymer. Other optional additives include TiO₂, which is used as a whitening agent; optical brighteners; surfactants; processing aids; etc.

Blends

The ionomers of the present invention could be blended with conventional ionomeric copolymers (di-, ter-, etc.) , using well-known techniques, to manipulate product properties as desired. The blends would still exhibit lower hardness and higher resilience when compared with blends based on conventional ionomers, as illustrated in the examples below. Non-limiting, illustrative examples of such conventional ionomers are E/15MAA/Na, E/19MAA/Na, E/15AA/Na, E/19AA/Na, E/15MAA/Mg and E/19MAA/Li. These ionomeric blends are considered to be within the scope of the present invention to the extent that they fall within the defined areas of FIG. 1, e.g., within area A₁-A₂-N.

Also, the ionomers of the present invention could be blended with non-ionic thermoplastic resins to manipulate product properties. The non-ionic thermoplastic resins would, by way of non-limiting illustrative examples, include thermoplastic elastomers, such as polyurethane, poly-ether-ester, poly-amide-ether, polyether-urea, PEBAX (a family of block copolymers based on polyether-block-amide, commercially suppled by Atochem), styrene-butadiene-styrene (SBS) block copolymers, styrene(ethylene-butylene)-styrene block copolymers, etc., poly amide (oligomeric and polymeric), polyesters, polyolefins including PE, PP, E/P copolymers, etc., ethylene copolymers with various comonomers, such as vinyl acetate, (meth)acrylates, (meth)acrylic acid, epoxy-functionalized monomer, CO, etc., functionalized polymers with maleic anhydride grafting, epoxidization etc., elastomers, such as EPDM, metallocene catalyzed PE and copolymer, ground up powders of the thermoset elastomers, etc.

Selection of Materials for Golf Balls

The specific combinations of resilience and compression used in the practice of the subject invention will in large part be dependent upon the type of golf ball desired (e.g., one-piece, two-piece, three-piece, or multi-layered), and in the type of performance desired for the resulting golf ball as detailed below.

Covers

Covers for golf balls comprising the soft, high resilient ionomer described above or its blends with other ionomers or non-ionomeric thermoplastic resins are included in the invention. The covers can be made by injection or compression molding the soft, high resilient ionomer described above (with or without organic acid or filler, other components, and other thermoplastics including other ionomers) over a thermoplastic or thermoset core of a two-piece golf ball, over windings around a thermoplastic or thermoset center, or as the outer layer of a multi-layer golf ball.

Multi-Layer Golf Ball Preferred Embodiments

Multi-layer balls are manufactured by well-known techniques wherein an injection or compression molded core is covered by one or more intermediate layers or mantles and an outer cover by injection or compression molding. The core and/or the mantle(s) are made by injection or compression molding a sphere or layer of desired size or thickness from the soft, high resilient ionomer described above or its blends with other ionomers or non-ionomeric thermoplastic resins that is filled with sufficient filler to provide a golf ball meeting the weight limits (45 grams) set by the PGA. The amount of filler employed in the core and mantle(s) can be varied from 0 to about 60 wt. % depending on the size (thickness) of the components and the desired location of the weight in the ball, provided that the final ball meets the required weight limits. The filler can be used in the core and not in the mantle, in the mantle and not in the core, or in both. While not intending to be limiting as to possible combinations, this embodiment includes:

1. a core comprising the same composition used in the three-piece center with a mantle made of any composition known in the art,

2. a core comprising the same composition used in the two-piece core or three-piece center with a mantle made of the composition of this invention with or without filler. adjusted to provide a golf ball of the desired weight,

3. a core made of any composition (including thermoset compositions such as polybutadiene rubber) with a mantle made of the composition of this invention with or without filler provided that the weight of the finished golf ball meets the required limit.

Two-Piece Golf Ball Preferred Embodiments

Two-piece balls are manufactured by well-known techniques wherein covers are injection or compression molded over cores. For purposes of this invention, such cores are made by injection or compression molding a sphere of desired size from the soft, high resilient ionomer described above or its blends with other ionomers or non-ionomeric thermoplastic resins that is filled with sufficient filler to provide a core density of from about 1.14 gm/cc to about 1.2 gm/cc depending on the diameter of the core and the thickness and composition of the cover to produce a golf ball meeting the weight limits (45 grams) set by the PGA.

Three-Piece Golf Ball Preferred Embodiments

Three-piece balls are manufactured by well-known techniques as described in, e.g., U.S. Pat. No. 4,846,910. For purposes of this invention, the center of these three-piece balls is made by injection or compression molding a sphere of desired size from the soft, high resilient ionomer described above or its blends with other ionomers or non-ionomeric thermoplastic resins that is filled with sufficient filler to provide a center density of from about 1.6 gm/cc to about 1.9 gm/cc depending on the diameter of the center, the windings, and the thickness and composition of the cover to produce a golf ball meeting the weight limits (45 grams) set by the PGA.

One-Piece Golf Ball Preferred Embodiments

One-piece balls can be made by well-known injection or compression techniques. They will have a traditional dimple pattern and may be coated with a urethane lacquer or be painted for appearance purposes, but such a coating and/or painting will not affect the performance characteristics of the ball.

The one-piece ball of this invention is made by injection or compression molding a sphere of desired size from the soft, high resilient ionomer described above or its blends with other ionomers or non-ionomeric thermoplastic resins that is filled with sufficient filler to provide a golf ball meeting the weight limits (45 grams) set by the PGA. Preferably, enough filler is used so that the ball has a density 1.14 gm/cc.

### EXAMPLES

Testing Criteria for Examples

Coefficient of Restitution (COR) is measured by firing an injection-molded neat sphere of the resin having the size of a golf ball from an air cannon at a velocity determined by the air pressure. The initial velocity generally employed is 125 feet/second. The sphere strikes a steel plate positioned three feet away from the point where initial velocity is determined, and rebounds through a speed-monitoring device located at the same point as the initial velocity measurement. The return velocity divided by the initial velocity is the COR.

PGA Compression is defined as the resistance to deformation of a golf ball, measured using an Atti machine.

The Atti Compression Gauge is designed to measure the resistance to deformation or resistance to compression of golf balls that are 1.680 inches in diameter. In these examples, smaller spheres approximately 1.53 inches in diameter were used. Spacers or shims were used to compensate for this difference in diameter. The sphere diameters were measured. A shim thickness was calculated such that the sphere diameter plus shim thickness equaled 1.680 inches. Then the PGA compression of the sphere and shim was measured.

A set of shims of different thicknesses were used to correct the sphere diameter plus shim thickness to within 0.0025 inches of 1.680 inches. After the PGA compression measurement was made, the value was mathematically corrected to compensate for any deviation from 1.680 inches. If the sphere diameter plus shim thickness was less than 1.680 inches, for every 0.001 inch less than 1.680 inches, 1 compression unit was added. If the sphere diameter plus shim thickness was greater than 1.680 inches, for every 0.001 inch greater than 1.680 inches, 1 compression unit was subtracted.

Melt Index (MI) was measured in accord with ASTM D-1238, condition E, at 190° C., using a 2160-gram weight, with values of MI reported in grams/10 minutes.

Example Processes

Employing a Werner & Pfleiderer (W&P) twin screw extruder, the stoichiometric amount of magnesium hydroxide in the form of concentrate needed to neutralize the target amount of acid in the acid copolymer (Target % Neut.) was pre-blended with the acid copolymer as a pellet blend. The pellet blend was melt mixed and neutralized in the W&P twin screws extruder under the conditions described in Table I and in the presence of added H₂O. Examples 1 through 11 and 14 through 26 in Table II are thus prepared in the twin-screw extrusion neutralization process. For Examples 15, 16, 18, 19, and 20, the resin was partially neutralized on a first pass through the extruder and then, to lower the MI, was passed through the extruder several additional times with more than the stoichiometric amount of Mg(OH)₂ needed to obtain nominally 100% neutralization on each pass (on a cumulative basis), but otherwise the same operating conditions.

The same neutralization process was employed for the Na or Li ionomers (Example 12 and 13 in Table II) using the stoichiometric amount of the sodium carbonate or lithium hydroxide in the concentrate form needed to reach target percent neutralization pre-blended with the acid copolymer base resin, followed by the melt mixing and neutralization through the W&P twin screw extruder under the same process conditions.

Example 26 in Table III was prepared by melt blending the already partially neutralized acid copolymer described above with 15% weight percent of magnesium stearate in a W&P twin screws extruder. Example 27 and 28 in Table III were prepared by melt blending the unneutralized acid copolymers described above with 40% weight percent of magnesium stearate and the Mg(OH)₂ neutralizing agent to achieve nominally 100% neutralization in a W&P twin screws extruder under the same process conditions. Example 29 was prepared by melt blending Example 25 and Ionomer-8 at a 50:50 weight ratio through a W & P twin screw extruder. It is noted that Comparative Example 38 was prepared at the same time as Example 29 using the same ionomer-8.

TABLE I
Extrusion Conditions for Preparing Ionomers

| Screw | Zone 1 | Zone | Zone | | | |
|---|---|---|---|---|---|---|
| Speed | Temp | 2-3 | 4-9 | Die | Rate | Vac. |
| Rpm | ° C. | Temp ° C. | Temp ° C. | Temp ° C. | lb./hr | Inches |
| 100-300 | 75-100 | 125-160 | 140-260 | 200-230 | 5-25 | 28 |

TABLE II
Soft and Resilient Ionomer Examples

| | | Cation | Target % | Ionomer MI |
|---|---|---|---|---|
| Ex. # | Resin Composition | Type | Neut. | (g/10 min.) |
| 1 | E/23.2nBA/8.6MAA/206MI | Mg | 85 | 2.1 |
| 2 | E/20.7nBA/8.7MAA/206MI | Mg | 95 | 1.1 |
| 3 | E/17.2nBA/9MAA/203MI | Mg | 75 | 1.1 |
| 4 | E/23.3nBA/8.5MAA/200MI | Mg | 78 | 0.7 |
| 5 | E/24.3nBA/9.3MAA/115MI | Mg | 65 | 1.1 |
| 6 | E/24.2nBA/9.3MAA/78MI | Mg | 55 | 1 |
| 7 | E/20.0nBA/9.5MAA/204MI | Mg | 70 | 3.4 |
| 8 | E/20.0nBA/9.5MAA/204MI | Mg | 75 | 0.4 |
| 9 | E/21.2nBA/9.1AA/114MI | Mg | 55 | 1.4 |
| 10 | E/21.3nBA/8.7AA/195MI | Mg | 65 | 1.6 |
| 11 | E/23.5nBA/9MAA/190MI | Mg | 78 | 1 |
| 12 | E/23.5nBA/9MAA/190MI | Na | 78 | 2.5 |
| 13 | E/23.5nBA/9MAA/190MI | Li | 78 | 2.3 |
| 14 | E/25.6nBA/5MAA/207MI | Mg | 85 | 3.2 |
| 15 | E/26.5nBA/2.4MAA/208MI | Mg | 100 | 22.5 |
| 16 | E/26.8nBA/5.2MAA/190MI | Mg | 100 | 5.1 |
| 17 | E/26nBA/9MAA/195MI | Mg | 85 | 4.1 |
| 18 | E/29.2nBA/5.3MAA/205MI | Mg | 100 | 6.1 |
| 19 | E/27.6nBA/2.4AA/190MI | Mg | 100 | 20.4 |
| 20 | E/26.6nBA/4.9AA/195MI | Mg | 100 | 4 |
| 21 | E/26.8nBA/8.4AA/185MI | Mg | 70 | 2.1 |
| 22 | E/29.6nBA/5.1AA/208MI | Mg | 80 | 2.1 |
| 23 | E/26.2nBA/4.2AA/72MI | Mg | 50 | 7.2 |
| 24 | E/24.9nBA/9.6AA/71MI | Mg | 50 | 1.8 |
| 25 | E/23.5nBA/8.2MAA/73MI | Mg | 65 | 1.2 |

TABLE III
Soft and Resilient Ionomer Composition Containing Mg Stearate

| | | | | | MI |
|---|---|---|---|---|---|
| | | Cation | Target | % Mg | (g/10 |
| Ex. # | Resin Composition | Type | % Neut. | Stearate | min.) |
| 26 | E/23.2nBA/8.6MAA/206MI | Mg | 86 | 15 | 0.7 |
| 27 | E/29.6nBA/5.1AA/208MI | Mg | ˜100 | 40 | 3.4 |
| 28 | E/26.8nBA/5.2MAA/190MI | Mg | ˜100 | 40 | 3.7 |

TABLE IIIA
Soft and Resilient Ionomeric Blend with Conventional Ionomer

| | Blend | | |
|---|---|---|---|
| Ex # | Composition | Cation Type | MI (g/10 min) |
| 29 | Ex. #25/Ionomer- | Mg/Na | 1.6 |
| | 8¹ (50:50 by wt.) | | |

¹Ionomer-8: E/19MAA/60MI and 37% neutralized by Na to 2.6MI

Thermoplastic Spheres

The above example resins were injection molded into 1.53 inch diameter spheres for property testing using injection molding conditions described in Table IV. The molded spheres are tested for the golf ball properties after 2 weeks of annealing at room temperature and the data reported in Table V.

TABLE IV
Molding Conditions for Injection Molding Spheres

| | Temp. ° C. |
|---|---|
| Rear | 183 |
| Center | 173 |
| Front | 173 |
| Nozzle | 177 |
| Mold Front/Back | 10 |
| Melt | 195 |
| | Pressures |
| | (Kg/cm²) |
| Injection 1st Stage | 130 |
| Injection 2nd Stage | 110 |
| Injection Hold | 13 |
| | Cycle Times |
| | (sec) |
| Pack | 10 |
| Hold | 480 |
| Booster | 10 |
| Cure Time | 15 |
| Screw Retraction | 5.35 |

TABLE V
Property of Molded Spheres

| | | PGA (ATTI) | |
|---|---|---|---|
| Ex. # | Designation | Compression | COR at 125 ft/sec. |
| 1 | — | 56 | 0.681 |
| 2 | — | 72 | 0.678 |
| 3 | — | 89 | 0.675 |
| 4 | — | 60 | 0.678 |
| 5 | — | 52 | 0.675 |
| 6 | — | 49 | 0.663 |
| 7 | — | 69 | 0.677 |
| 8 | — | 68 | 0.684 |
| 9 | — | 61 | 0.674 |
| 10 | — | 68 | 0.689 |
| 11 | — | 61 | 0.671 |
| 12 | — | 61 | 0.656 |
| 13 | — | 66 | 0.66 |
| 14 | — | 30 | 0.668 |
| 15 | — | 2 | 0.604 |
| 16 | — | 14 | 0.671 |
| 17 | — | 35 | 0.672 |
| 18 | — | 5 | 0.663 |
| 19 | — | 1 | 0.631 |
| 20 | — | 19 | 0.692 |
| 21 | — | 31 | 0.686 |
| 22 | — | 24 | 0.658 |
| 23 | — | 16 | 0.654 |
| 24 | — | 51 | 0.678 |
| 25 | — | NA | NA |
| 26 | — | 50 | 0.735 |
| 27 | — | 73 | 0.774 |
| 28 | — | 69 | 0.762 |
| 29 | — | 133 | 0.677 |
| Comp. #30 | Ionomer-1 | 64 | 0.632 |
| Comp. #31 | Ionomer-2 | 39 | 0.582 |
| Comp. #32 | Ionomer-3 | 66 | 0.627 |
| Comp. #33 | Ionomer-4 | 34 | 0.575 |
| Comp. #34 | Ionomer-5 | 124 | 0.671 |
| Comp. #35 | Ionomer-6 | 106 | 0.694 |
| Comp. #36 | Ionomer-7 | 108 | 0.673 |
| Comp. #37 | Ionomer-8 | 160 | 0.753 |
| Comp. #38 | Ionomer-1/Ionomer-8 | 140 | 0.667 |
| | (50:50 by wt.) | | |

Ionomer-1: E/23.5nBA/9MAA/25MI; Mg neutralized to 51% and 0.95MI
Ionomer-2: E/23.5nBA/9MAA/25MI; Na neutralized to 52% and 1.0MI
Ionomer-3: E/23.5nBA/9MAA/25MI; Li neutralized to 47% and app. 1.0MI
Ionomer-4: E/23.5nBA/9MAA/25MI; Zn neutralized, to 51% and 0.75MI
Ionomer-5: 50/50 blend of Ionomer-1 and a 37% Na neutralized, 2.6MI E/19MAA/60MI Ionomer
Ionomer-6: E/15.2nBA/8.78AA/61.4MI; Mg neutralized to 78% and 0.8MI
Ionomer-7: E/15.2nBA/8.78AA/61.4MI; Mg neutralized to 65% and 1.9MI

The ionomers of Examples 29, 37 and 38 include Ionomer 8 and, accordingly, include copolymers that are nominally E/19MAA/60MI neutralized by Na to nominally 37%. Similarly, Examples 34 and 38 both include Ionomer 1.

The examples demonstrate significantly enhanced property balance between resilience (higher COR at 125 ft/second) and softness (lower PGA compression) in reference to the current ionomers from the conventional art. It is particularly worth noting that this invention has enabled significantly improved resilience with lower stiffness for the magnesium ionomers when compared to the blended composition (comparative examples 34 and 38) from the conventional art. The Na or Li ionomers exhibited significant resilience enhancement comparing to Ionomer-2 and Ionomer-3 from the conventional art. It is noted that while the properties of ionomeric blend of Example 29 fell above the A₁-A₂ line of FIG. 1, use of higher levels of the Example 25 ionomer would be expected to drop the properties below the line.

The soft and resilient ionomer compositions could be further modified with other ionomers and thermoplastic elastomers for property modifications, inorganic fillers for specific gravity adjustment, processing aids and stabilizers for processing and stability enhancement to be used for various parts of golf balls.

The spheres made using the soft, resilient ionomer resins (SRI resins) of Examples 1,2 and 4-23 had unexpected higher COR's or lower PGA compression's than spheres made from the conventional “soft ionomers,” and the Comparative Examples.

1. At least one E/X/Y copolymer where E is ethylene, X is a C₃ to C₈ α,β ethylenically unsaturated carboxylic acid, and Y is a softening comonomer selected from alkyl acrylate and alkyl methacrylate wherein the alkyl groups have from 1-8 carbon atoms, wherein
a. X is about 2-30 wt. % of the E/X/Y copolymer, and is at least partially neutralized by one or more alkali metal, transition metal, or alkaline earth metal cation
b. Y is about 17-40 wt. % of the E/X/Y copolymer, and
c. the copolymer has a melt index and a degree of neutralization such that the copolymer has an Atti Compression and a Coefficient of Restitution that each, independently, falls within area A₁- A₂-N of FIG. 1.

2. The copolymer of claim 1, wherein X is about 4-20 wt. % of the E/X/Y copolymer and Y is about 20-40 wt. % of the E/X/Y copolymer.

3. The copolymer of claim 2, wherein X is about 5-15 wt. % of the E/X/Y copolymer and Y is about 24-35 wt. % of the E/X/Y copolymer.

4. The copolymer of claim 1, wherein the Atti Compression and Coefficient of Restitution each, independently, falls within area B₁-B₂-N of FIG. 1.

5. The copolymer of claim 1, wherein the Atti Compression and Coefficient of Restitution each, independently, falls within area C₁-C₂-N of FIG. 1.

6. The copolymer of claim 1, wherein the Atti Compression and Coefficient of Restitution each, independently, falls within area D₁-D₂-N of FIG. 1.

7. The copolymer of claim 1, wherein the Atti Compression and Coefficient of Restitution each, independently, falls within area E₁-E₂-N of FIG. 1.

8. The copolymer of claim 1, having a melt index measured in accordance with ASTM D-1238, condition E, at 190° C. using a 2160 gram weight of at least 0.1.

9. The copolymer of claim 1, having a melt index measured in accordance with ASTM D-1238, condition E, at 190° C. using a 2160 gram weight of at least 0.5.

10. The copolymer of claim 1, having a melt index measured in accordance with ASTM D-1238, condition E, at 190° C. using a 2160 gram weight of 1.0 or greater.

11. The copolymer of claim 1, wherein the weight ratio of X to Y in the copolymer is at least about 1:20.

12. The copolymer of claim 11, wherein the weight ratio of X to Y in the copolymer is at least about 1:15.

13. The copolymer of claim 12, wherein the weight ratio of X to Y in the copolymer is at least about 1:10.

14. The copolymer of claim 1, wherein the weight ratio of X to Y in the copolymer is up to about 1:1.67

15. The copolymer of claim 11, wherein the weight ratio of X to Y in the copolymer is up to about 1:1.67.

16. The copolymer of claim 15, wherein the weight ratio of X to Y in the copolymer is up to about 1.2.

17. The copolymer of claim 12, wherein the weight ratio of X to Y in the copolymer is up to about 1.2.

18. The copolymer of claim 13, wherein the weight ratio of X to Y in the copolymer is up to about 1.2.

19. The copolymer of claim 1, wherein at least about 40% of X is neutralized.

20. The copolymer of claim 19, wherein at least about 55% of X is neutralized.

21. The copolymer of claim 20, wherein at least about 70% of X is neutralized.

22. The copolymer of claim 21, wherein at least about 80% of X is neutralized

23. The copolymer of claim 1, wherein X is methacrylic acid or acrylic acid.

24. The copolymer of claim 23, wherein Y is n-butyl acrylate.

25. The copolymer of claim 1, which is melt-processible.

26. A composition consisting essentially of a blend of (a) the copolymer of claim 1 and (b) one or more at least partially neutralized organic acid(s) or salt(s) thereof.

27. The composition of claim 26, consisting essentially of a blend of (a) the copolymer of claim 1 and (b) about 5 to 50 weight percent based on total of (a) and (b) of one or more at least partially neutralized, aliphatic, mono-functional organic acids having fewer than 36 carbon atoms or salt(s) thereof.

28. The composition of claim 27, wherein greater than 80% of all the acid components in the blend are neutralized.

29. The composition of claim 28, wherein greater than 90% of all the acid components in the blend are neutralized.

30. The composition of claim 27, wherein component (b) is one or more fatty acids or fatty acid salts.

31. A composition consisting essentially of a blend of (a) the copolymer of claim 1 and (b) one or more other ionomeric copolymer(s).

32. A composition consisting essentially of a blend of (a) the copolymer of claim 1 and (b) one or more thermoplastic resins.

33. A cover of a golf ball comprising the copolymer of claim 1.

34. The core of a two-piece golf ball comprising the copolymer of claim 1.

35. The center of a three-piece golf ball comprising the copolymer of claim 1.

36. The core, mantle, or one or more intermediate layers of a multi-layered golf ball comprising the copolymer of claim 1.

37. A one-piece golf ball comprising the copolymer of claim 1.

38. The cover of a golf ball comprising the copolymer of claim 30.

39. The core of a two-piece golf ball comprising the composition of claim 30.

40. The center of a three-piece golf ball comprising the composition of claim 30.

41. The core, mantle, or one or more intermediate layers of a multi-layered golf ball comprising the composition of claim 30.

42. A one-piece golf ball comprising the copolymer of claim 30.
